(19) United States
(12) Patent Application Publication
(10) Pub. No.: US 2001/0006340 A1
(43) Pub. Date: Jul. 5, 2001

(54) Circuit configuration for generating an auxiliary DC voltage

(76) Inventor: Thomas Meier, Munchen (DE)

Correspondence Address: Lerner and Greenberg, P.A., P.O. Box 2480, Hollywood, FL, 33022-2480, US

(21) Appl. No.: 09/761,814

(22) Filed: Jan. 16, 2001

Related U.S. Application Data
(63) Continuation of application No. PCT/DE99/01972, filed on Jul. 1, 1999.

(30) Foreign Application Priority Data
Jul. 14, 1998 (DE) 198 31 561.9

(51) Int. Cl. G05F 1/40

(52) U.S. Cl. 323/282

(57) ABSTRACT

The circuit generates an auxiliary direct current voltage from a supply voltage for a circuit element conducting a high-frequency useful signal. The circuit has a voltage converter controlled by the high-frequency useful signal, and its working frequency is identical to the frequency of the high-frequency useful signal.

### CROSS-REFERENCE TO RELATED APPLICATION

This is a continuation of copending International Application PCT/DE99/01972, filed Jul. 1, 1999, which designated the United States.

### BACKGROUND OF THE INVENTION

Field of the Invention

The invention relates to a circuit configuration for generating an auxiliary DC voltage from a supply voltage for a circuit component that conducts a useful signal (user signal) in the radio-frequency range.

Measurement field-effect transistors which are typically used in extra-high frequency amplifiers and are based, for example, on gallium arsenide require a negative voltage at the gate in order to set the working point. In particular in high-power amplifiers this voltage is necessary to reach a high level of efficiency. Because otherwise negative voltage is usually not required in many apparatuses which are, for example, battery-operated, it is desirable to generate this negative voltage on the actual amplifier chip.

To do this, free-wheeling oscillators are used on the chip or clock signals which are already available are used on the chip. However, owing to the fixed frequencies, in both cases undesired spectral lines are generated which have to be suppressed with considerable effort in order to fulfill system requirements and irradiation guidelines.

### SUMMARY OF THE INVENTION

It is accordingly an object of the invention to provide a circuit configuration for generating an auxiliary direct voltage, which overcomes the above-mentioned disadvantages of the heretofore-known devices and methods of this general type.

With the foregoing and other objects in view there is provided, in accordance with the invention, a circuit configuration for generating an auxiliary DC voltage from a DC supply voltage for a circuit component processing a radio-frequency user signal, comprising:

a voltage converter driven by a radio-frequency user signal and having an operating frequency equal to a frequency of the radio-frequency user signal;

the voltage converter having terminals for applying a DC supply voltage and an output outputting an auxiliary DC voltage to be fed into a circuit component;

the voltage converter having a capacitor connected between ground and a second node, a first diode connected between the second node and a first node, and a second diode connected between the first node and one of the terminals for the DC supply voltage.

In accordance with an added feature of the invention, the second diode is connected to ground and the auxiliary DC voltage has a polarity opposite a polarity of the DC supply voltage. In the alternative, the second diode is connected to the DC supply voltage and the auxiliary DC voltage has a polarity equal to and is a multiple of the DC supply voltage.

In accordance with an additional feature of the invention, the voltage converter includes a rectifier unit configured to rectify the radio-frequency user signal to generate the auxiliary DC voltage.

In accordance with another feature of the invention, at least one amplifier stage is connected upstream of the rectifier unit in a signal flow direction.

In accordance with a further feature of the invention, the second diode is connected to ground and the auxiliary DC voltage has a polarity opposite a polarity of the DC supply voltage, the rectifier unit has a first capacitor feeding the radio-frequency user signal to the first node, a third node connected to the second diode, a first resistor connected between the second node and the third node, and a second resistor connected between the third node and an input of at least one of the amplifier stages, whereby the second node carries the auxiliary DC voltage.

In accordance with again a further feature of the invention, a third resistor is connected in series with the second diode.

In accordance with yet a further feature of the invention, the radio-frequency user signal is an input signal of an amplifier contained in the circuit component which conducts the radio-frequency user signal.

In accordance with a concomitant feature of the invention, the DC voltage is provided at the output of the voltage converter for generating the bias voltage of a stage of the radio-frequency amplifier which conducts the radio-frequency user signal.

In other words, the circuit configuration according to the invention for generating an auxiliary DC voltage from a supply voltage for a circuit component which conducts a radio-frequency user signal, has a voltage converter which is driven by the radio-frequency user signal and whose operating frequency is the same as the frequency of the radio-frequency user signal.

Because the operating frequency of the voltage converter is always the same as the radio-frequency user signal in the present invention, no extraneous frequencies, and therefore no additional spectral lines, occur. As a result of the absence of these additional spectral lines, the auxiliary DC voltage is of high spectral purity. An alternating signal which is superposed on the auxiliary DC voltage only has the frequency of the radio-frequency user signal. If this spectrally very pure auxiliary DC voltage is fed to the circuit component which conducts the radio-frequency user signal, apart from possibly a non-interfering signal with the frequency of the radio-frequency user signal, no further spectral elements are added. In this way, no complex suppression measures for undesired spectral elements are necessary and the circuit configuration according to the invention is therefore also used for applications which require maximum spectral purity, for example power amplifiers for CDMA (Code Division Multiple Access) apparatuses.

Depending on the embodiment, the circuit configuration according to the invention can be used both to multiply the supply voltage and to generate a voltage with opposite polarity to that of the supply voltage. Finally, the circuit configuration according to the invention also has the advantage that, owing to the use of a radio-frequency signal for auxiliary DC voltage generation, circuit elements such as block capacitors can be made so small that they can be integrated into a chip.

A preferred voltage converter has a rectifier unit which rectifies the radio-frequency user signal to generate the auxiliary DC voltage. In this way, the auxiliary DC voltage is generated with little effort while maintaining the spectral and chronological profiles of the radio-frequency user signal. In order to generate the desired value of the auxiliary DC voltage, it is possible here to connect at least one amplifier stage in front of the rectifier unit.

Depending on the polarity, the rectifier unit permits the voltage to be multiplied and/or the polarity of the supply voltage to be inverted with little expenditure on circuitry. Such rectifier units are composed in the simplest case of two capacitors and two diodes. The two capacitors are connected here to the diodes in such a way that one of the two capacitors is charged at one of the half waves of an alternating voltage signal and at the other half wave its voltage is turned round in order to invert the voltage and at the same time it is connected to the second capacitor. In another rectifier unit, a capacitor is charged during a half wave of the alternating signal, and at the other half wave it is added to the alternating signal for the purpose of doubling the voltage, and fed to the second capacitor.

The preferred rectifier units for generating an opposite polarity of the auxiliary DC voltage with respect to the DC supply voltage preferably have a first capacitor via which the radio-frequency signal is fed to the first node. A second capacitor is connected here between a reference potential and a second node. In addition, a first diode is connected between the first and second nodes, and a second diode is connected between the first node and a third node. Finally, a first resistor is connected between the second and third nodes, and a second resistor is connected between the third node and the input of at least one amplifier stage. The auxiliary DC voltage can be tapped at the second node. The two nodes bring about the rectification here, the first capacitor serving to invert the voltage and the second serving to smooth the rectified signal.

The circuit component which conducts the radio-frequency signal can have a radio-frequency amplifier whose input signal forms the radio-frequency user signal. The auxiliary DC voltage at the output of the voltage converter can serve, for example, to generate a bias voltage of at least one stage of the radio-frequency amplifier.

Other features which are considered as characteristic for the invention are set forth in the appended claims.

Although the invention is illustrated and described herein as embodied in a circuit configuration for generating an auxiliary DC voltage, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a circuit diagram of a first, general embodiment of a circuit configuration according to the invention;

FIG. 2 is a diagram of a rectifier unit for generating an inverse voltage with respect to the voltage supply in the exemplary embodiment according to FIG. 1;

FIG. 3 is a diagram of a rectifier unit for generating a multiple of the supply voltage in the circuit configuration according to claim 1; and

FIG. 4 is a circuit diagram of a preferred embodiment of a circuit configuration according to the invention.

### DESCRIPTION OF THE PREFERRED EMBODIMENTS

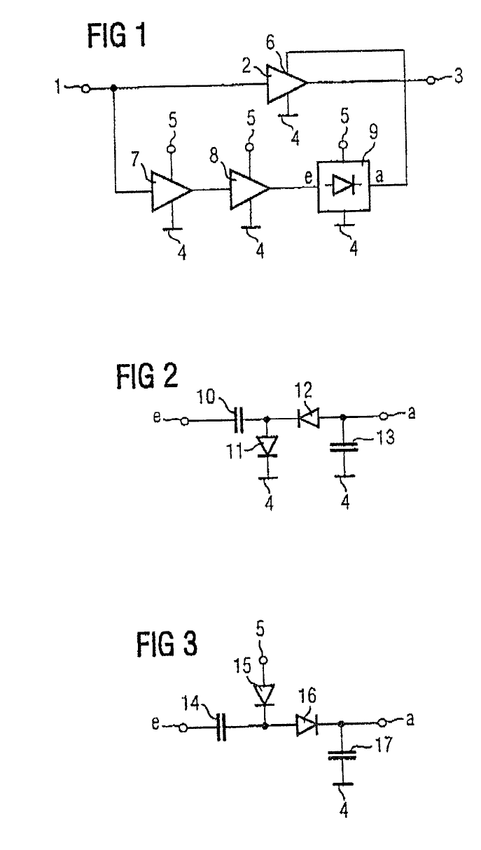

Referring now to the figures of the drawing in detail and first, particularly, to FIG. 1 thereof, there is shown a general exemplary embodiment of the invention. There, a radio-frequency user signal 1 is fed to an amplifier circuit 2 and amplified by the circuit 2 to form an output signal 3. In the present exemplary embodiment, the amplifier circuit 2 requires a higher operating voltage than a supply voltage which is available and which can be tapped between ground 4 and a supply terminal 5. In order to generate the higher operating voltage 6, the radio-frequency user signal 1 is fed to amplifier stages 7 and 8 which are connected in series, and is amplified by them. The amplified radio-frequency user signal 1 is then fed to the input e of a rectifier unit 9, which generates therefrom an auxiliary DC voltage 6 which is referred to ground 4 and is twice as high as the supply voltage which can be tapped between the terminals 4 and 5. Instead of a multiple of the supply voltage 4, 5, a negative auxiliary DC voltage can also be generated by appropriately selecting the rectifier unit 9.

With reference to FIG. 2, there is illustrated a rectifier unit 9 for generating a negative auxiliary DC voltage from a positive supply voltage 4, 5. An input e of the rectifier unit 9, to which input the amplified, radio-frequency user signal 1 is applied, is fed via a capacitor 10 to a node which is connected both to the anode terminal of a diode 11 and to the cathode terminal of a diode 12. The cathode terminal of the diode 11 is connected to ground 4. The anode of the diode 12 forms, on the one hand, an output a of the rectifier unit 9 and is, on the other hand, also connected to ground 4 via a capacitor 13. The capacitor 10 serves here to extract the alternating element in the signal which is applied to the input e. The alternating signal is subsequently rectified by means of diodes 11 and 12. In order to generate a DC voltage, for example, from a negative supply voltage, the polarity of the diodes 11 and 12 has to be appropriately reversed.

FIG. 3 shows an embodiment of the rectifier unit 9 for generating a multiple of the supply voltage 6 at its output a from a signal from the input e. The anode and cathode terminals, respectively, of the two diodes 15 and 16 are connected here to one another and to the input e via a capacitor 14. The cathode terminal of the diode 15 is connected to the supply terminal 5, and the anode terminal of the diode 16 is connected to ground 4 via a capacitor 17. In addition, the anode terminal of the diode 16 forms the output a of the rectifier unit 9, at which output a an operating voltage can be tapped with respect to the supply voltage 4, 5. In addition to the exemplary embodiment shown here, a doubled negative voltage can be acquired at the input e from a negative supply voltage in the same way by reversing the polarity of the diodes 15 and 16.

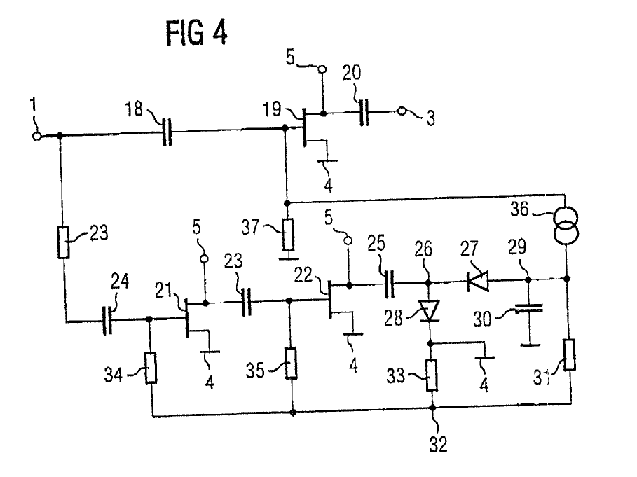

In the preferred exemplary embodiment according to FIG. 4, the radio-frequency user signal is fed to an extra-high frequency amplifier, which essentially has a gallium-arsenide measurement field-effect transistor. The source terminal of the field-effect transistor 19 is connected to ground 4 and its drain terminal is connected to the supply voltage 5, for example with the intermediate connection of a resistor (not shown). The feeding in of the radio-frequency user signal is carried out by means of a capacitor 18 to the gate terminal of the field-effect transistor 19. On the output side, the amplified signal is taken from the drain terminal of the field-effect transistor 19 and extracted via a capacitor 20.

In order to generate a negative voltage for use as a bias voltage at the gate of the field-effect transistor 19, the radio-frequency user signal is fed to two amplifier stages which are connected in series and which also each have gallium-arsenide measurement field-effect transistors 21 and 22. The drain and source terminals of the field-effect transistors 21 and 22 are connected to ground 4 and to the supply voltage 5 in the same way as the field-effect transistor 19. The radio-frequency user signal is fed to the gate terminal of the field-effect transistor 21 via a series circuit of a resistor 23 and a capacitor 24. The field-effect transistors 21 and 22 are connected via a capacitor 23 between the source terminal of the field-effect transistor 21 and the gate terminal of the field-effect transistor 22. The rectifier unit which is connected downstream of the source terminal of the field-effect transistor, comprises a capacitor 25 which is connected between the source terminal of the field-effect transistor 22 and a node 26. The node 26 is connected to the cathode of a diode 27 and to the anode of a diode 28. The anode terminal of the diode 27 is connected to a node 29 which is also connected to ground 4 via a capacitor 30 and to a node 32 via a resistor 31, and is finally connected, with the intermediate connection of a current source 36, to the gate terminal of the field-effect transistor 19 in order to make available the negative bias voltage. The gate terminal of the field-effect transistor 19 is connected to ground 4 via a resistor 37. The current source 36 and the resistor 37 together form a voltage regulator. Here, under certain circumstances, the current source 36 can, for example, also be replaced by a resistor. The cathode terminal of the diode 28 is connected to ground 4, as is a resistor 33. The other terminal of the resistor 33 is connected to the node 32. Finally, the gate terminals of the field-effect transistors 21 and 22 are also supplied with a negative bias voltage by connecting a resistor 34 or 35 between the node 32 and the gate terminal of the field-effect transistor 21 or 22.

I claim:

1. A circuit configuration for generating an auxiliary DC voltage from a DC supply voltage for a circuit component processing a radio-frequency user signal, comprising:
a voltage converter driven by a radio-frequency user signal and having an operating frequency equal to a frequency of the radio-frequency user signal;
said voltage converter having terminals for applying a DC supply voltage and an output outputting an auxiliary DC voltage to be fed into a circuit component;
said voltage converter having a capacitor connected between ground and a second node, a first diode connected between said second node and a first node, and a second diode connected between said first node and one of said terminals for the DC supply voltage.

2. The circuit configuration according to claim 1, wherein said second diode is connected to ground and the auxiliary DC voltage has a polarity opposite a polarity of the DC supply voltage.

3. The circuit configuration according to claim 1, wherein said second diode is connected to the DC supply voltage and the auxiliary DC voltage has a polarity equal to and is a multiple of the DC supply voltage.

4. The circuit configuration according to claim 1, wherein said voltage converter includes a rectifier unit configured to rectify the radio-frequency user signal to generate the auxiliary DC voltage.

5. The circuit configuration according to claim 4, which comprises at least one amplifier stage connected upstream of said rectifier unit in a signal flow direction.

6. The circuit configuration according to claim 5, wherein said second diode is connected to ground and the auxiliary DC voltage has a polarity opposite a polarity of the DC supply voltagesaid rectifier unit has a first capacitor feeding the radio-frequency user signal to said first node, a third node connected to said second diode, a first resistor connected between said second node and said third node, and a second resistor connected between said third node and an input of at least one of said amplifier stages, whereby said second node carries the auxiliary DC voltage.

7. The circuit configuration according to claim 6, which comprises a third resistor connected in series with said second diode.

8. The circuit configuration according to claim 1, wherein the radio-frequency user signal is an input signal of an amplifier contained in the circuit component which conducts the radio-frequency user signal.

9. The circuit configuration according to claim 8, wherein the DC voltage is provided at the output of said voltage converter for generating the bias voltage of a stage of the radio-frequency amplifier which conducts the radio-frequency user signal.
